(19) United States
(12) Patent Application Publication
(10) Pub. No.: US 2015/0009301 A1
(43) Pub. Date: Jan. 8, 2015

(54) METHOD AND APPARATUS FOR MEASURING THE THREE DIMENSIONAL STRUCTURE OF A SURFACE

(71) Applicant: 3M INNOVATIVE PROPERTIES COMPANY, St. Paul, MN (US)

(72) Inventors: Evan J. Ribnick, St. Louis Park, MN (US); Yi Qiao, Santa Clara, CA (US); Jack W. Lai, Lake Elmo, MN (US); David L. Hofeldt, Oakdale, MN (US)

(21) Appl. No.: 14/375,002

(22) PCT Filed: Jan. 30, 2013
(86) PCT No.: PCT/US13/23789

§ 371 Date: Jul. 28, 2014

Related U.S. Application Data
(60) Provisional application No. 61/593,197, filed on Jan. 31, 2012.

(51) Int. Cl. G06T 17/10; H04N 13/02; G01B 11/24

(52) U.S. Cl. CPC G06T 17/10; G01B 11/24; H04N 13/0221; G06T 2200/04; G06T 2200/08; G06T 2207/10028; G06T 2207/30124; G06T 2219/2004
USPC 348/50

(57) ABSTRACT

A method includes imaging a surface with at least one imaging sensor, wherein the surface and the imaging sensor are in relative translational motion. The imaging sensor includes a lens having a focal plane aligned at a non-zero angle with respect to an x-y plane of a surface coordinate system. A sequence of images of the surface is registered and stacked along a z direction of a camera coordinate system to form a volume. A sharpness of focus value is determined for each (x,y) location in the volume, wherein the (x,y) locations lie in a plane normal to the z direction of the camera coordinate system. Using the sharpness of focus values, a depth of maximum focus zₘ along the z direction in the camera coordinate system is determined for each (x,y) location in the volume, and based on the depths of maximum focus zₘ, a three dimensional location of each point on the surface may be determined.

### CROSS REFERENCE TO RELATED APPLICATIONS

This application claims the benefit of U.S. Provisional Application No. 61/593,197, filed Jan. 31, 2012, the disclosure of which is incorporated by reference herein in its entirety.

### TECHNICAL FIELD

The present disclosure relates to a method and optical inspection apparatus for determining a three-dimensional structure of a surface. In another aspect, the present disclosure relates to material inspection systems, such as computerized systems for the inspection of moving webs of material.

### BACKGROUND

Online measurement and inspection systems have been used to continuously monitor the quality of products as the products are manufactured on production lines. The inspection systems can provide real-time feedback to enable operators to quickly identify a defective product and evaluate the effects of changes in process variables. Imaging-based inspection systems have also been used to monitor the quality of a manufactured product as it proceeds through the manufacturing process.

The inspection systems capture digital images of a selected part of the product material using sensors such as, for example, CCD or CMOS cameras. Processors in the inspection systems apply algorithms to rapidly evaluate the captured digital images of the sample of material to determine if the sample, or a selected region thereof, is suitably defect-free for sale to a customer.

Online inspection systems can analyze two-dimensional (2D) image characteristics of a moving surface of a web material during the manufacturing process, and can detect, for example, relatively large-scale non-uniformities such as cosmetic point defects and streaks. Other techniques such as triangulation point sensors can achieve depth resolution of surface structure on the order of microns at production line speeds, but cover only a single point on the web surface (since they are point sensors), and as such provide a very limited amount of useful three-dimensional (3D) information on surface characteristics. Other techniques such as laser line triangulation systems can achieve full 3D coverage of the web surface at production line speeds, but have a low spatial resolution, and as such are useful only for monitoring large-scale surface deviations such as web curl and utter.

3D inspection technologies such as, for example, laser profilometry, interferometry, and 3D microscopy (based on Depth from Focus (DFF)) have been used for surface analysis. DFF surface analysis systems image an object with a camera and lens having a narrow depth of field. As the object is held stationary, the camera and lens are scanned depth-wise over various positions along the z-axis (i.e., parallel to the optical axis of the lens), capturing an image at each location. As the camera is scanned through multiple z-axis positions, points on the object's surface come into focus at different image slices depending on their height above the surface. Using this information, the 3D structure of the object surface can be estimated relatively accurately.

### SUMMARY

In one aspect, the present disclosure is directed to a method including imaging a surface with at least one imaging sensor, wherein the surface and the imaging sensor are in relative translational motion, and wherein the sensor includes a lens with a focal plane aligned at a non-zero viewing angle with respect to an x-y plane in a surface coordinate system; registering a sequence of images of the surface; stacking the registered images along a z direction in a camera coordinate system to form a volume; determining a sharpness of focus value for each (x,y) location in the volume, wherein the (x,y) locations lie in a plane normal to the z direction in the camera coordinate system; determining, using the sharpness of focus values, a depth of maximum focus zₘ along the z direction in the camera coordinate system for each (x,y) location in the volume; and determining, based on the depths of maximum focus zₘ, a three dimensional location of each point on the surface.

In another aspect, the present disclosure is directed to a method including capturing with an imaging sensor a sequence of images of a surface, wherein the surface and the imaging sensor are in relative translational motion, and wherein the imaging sensor includes a telecentric lens having a focal plane aligned at a non-zero viewing angle with respect to an x-y plane in a surface coordinate system; aligning a reference point on the surface in each image in the sequence to form a registered sequence of images; stacking the registered sequence of images along a z direction in a camera coordinate system to form a volume, wherein each image in the registered sequence of images comprises a layer in the volume; computing a sharpness of focus value for each pixel within the volume, wherein the pixels lie in a plane normal to the z direction in the camera coordinate system; computing, based on the sharpness of focus values, a depth of maximum focus value zₘ for each pixel within the volume; determining, based on the depths of maximum focus zₘ, a three dimensional location of each point on the surface; and constructing a three-dimensional model of the surface based on the three dimensional point locations.

In yet another aspect, the present disclosure is directed to an apparatus, including an imaging sensor with a telecentric lens, wherein the lens has a focal plane aligned at a non-zero viewing angle with respect to an x-y plane in a surface coordinate system, wherein the surface and the imaging sensor are in relative translational motion, and wherein the sensor images the surface to form a sequence of images thereof; a processor that: aligns in each image in the sequence a reference point on the surface to form a registered sequence of images; stacks the registered sequence of images along a z direction in a camera coordinate system to form a volume, wherein each image in the registered sequence of images comprises a layer in the volume; computes a sharpness of focus value for each pixel within the volume, wherein the pixels lie in a plane normal to the z direction in the camera coordinate system; computes, based on the sharpness of focus values, a depth of maximum focus value zₘ for each pixel within the volume; determines, based on the depths of maximum focus zₘ, a three dimensional location of each point on the surface; and constructs a three-dimensional model of the surface based on the three dimensional locations.

In yet another aspect, the present disclosure is directed to a method including positioning a stationary imaging sensor at a non-zero viewing angle with respect to a moving web of material, wherein the imaging sensor includes a telecentric lens to image a surface of the moving web and form a sequence of images thereof; processing the sequence of images to: register the images; stack the registered images along a z direction in a camera coordinate system to form a volume; determine a sharpness of focus value for each (x,y) location in the volume, wherein the (x,y) locations lie in a plane normal to the z direction in the camera coordinate system; determine a depth of maximum focus zₘ along the z direction in the camera coordinate system for each (x,y) location in the volume; and determine, based on the depths of maximum focus zₘ, a three dimensional location of each point on the surface of the moving web.

In yet another aspect, the present disclosure is directed to a method for inspecting a moving surface of a web material in real time and computing a three-dimensional model of the surface, the method including capturing with a stationary sensor a sequence of images of the surface, wherein the imaging sensor includes a camera and a telecentric lens having a focal plane aligned at a non-zero viewing angle with respect to an x-y plane of a surface coordinate system; aligning a reference point on the surface in each image in the sequence to form a registered sequence of images; stacking the registered sequence of images along a z direction in a camera coordinate system to form a volume, wherein each image in the registered sequence of images comprises a layer in the volume; computing a sharpness of focus value for each pixel within the volume, wherein the pixels lie in a plane normal to the z direction in the camera coordinate system; computing, based on the sharpness of focus values, a depth of maximum focus value zₘ for each pixel within the volume; determining, based on the depths of maximum focus zₘ, a three dimensional location of each point on the surface; and constructing the three-dimensional model of the surface based on the three dimensional locations.

In yet another aspect, the present disclosure is directed to an online computerized inspection system for inspecting web material in real time, the system including a stationary imaging sensor including a camera and a telecentric lens, wherein the lens has a focal plane aligned at a non-zero viewing angle with respect to a plane of a moving surface, and wherein the sensor images the surface to form a sequence of images thereof; a processor that: aligns in each image in the sequence a reference point on the surface to form a registered sequence of images; stacks the registered sequence of images along a z direction in a camera coordinate system to form a volume, wherein each image in the registered sequence of images comprises a layer in the volume; computes a sharpness of focus value for each pixel within the volume, wherein the pixels lie in a plane normal to the z direction in the camera coordinate system; computes, based on the sharpness of focus values, a depth of maximum focus value zₘ for each pixel within the volume; determines, based on the depths of maximum focus zₘ, a three dimensional location of each point on the surface; and constructs a three-dimensional model of the surface based on the three dimensional locations.

In yet another aspect, the present disclosure is directed to a non-transitory computer readable medium including software instructions to cause a computer processor to:receive, with an online computerized inspection system, a sequence of images of a moving surface of a web material, wherein the sequence of images is captured with a stationary imaging sensor including a camera and a telecentric lens having a focal plane aligned at a non-zero viewing angle with respect to an x-y plane of a surface coordinate system; align a reference point on the surface in each image in the sequence to form a registered sequence of images; stack the registered sequence of images along a z direction in a camera coordinate system to form a volume, wherein each image in the registered sequence of images comprises a layer in the volume; compute a sharpness of focus value for each pixel within the volume, wherein the pixels lie in a plane normal to the z direction in the camera coordinate system; compute, based on the sharpness of focus values, a depth of maximum focus value zₘ for each pixel within the volume; determine, based on the depths of maximum focus zₘ, a three dimensional location of each point on the surface; and construct the three-dimensional model of the surface based on the three dimensional locations.

In a further aspect, the present disclosure is directed to a method including translating an imaging sensor relative to a surface, wherein the sensor includes a lens with a focal plane aligned at a non-zero viewing angle with respect to an x-y plane of a surface coordinate system; imaging the surface with the imaging sensor to acquire a sequence of images; estimating the three dimensional locations of points on the surface to provide a set of three dimensional points representing the surface; and processing the set of three dimensional points to generate a range-map of the surface in a selected coordinate system.

In yet another aspect, the present disclosure is directed to a method, including: (a) imaging a surface with at least one imaging sensor to acquire a sequence of images, wherein the surface and the imaging sensor are in relative translational motion, and wherein the sensor includes a lens with a focal plane aligned at a non-zero viewing angle with respect to an x-y plane in a surface coordinate system; (b) determining a sharpness of focus value for every pixel in a last image in the sequence of images; (c) computing a y-coordinate in the surface coordinate system at which the focal plane intersects the y axis; (d) based on the apparent shift of the surface in the last image, determining transitional points on the surface, wherein the transitional points have exited a field of view of the lens in the last image, but were in the field of view of the lens in an image in the sequence previous to the last image; (e) determining the three dimensional location in a camera coordinate system of all the transitional points on the surface; (f) repeating steps (a) to (f) for each new image acquired by the imaging sensor; and (g) accumulating the three dimensional location in the camera coordinate system of the transitional points from the images in the sequence to form a point cloud representative of the translating surface.

In yet another embodiment, the present disclosure is directed to an apparatus, including an imaging sensor with a lens having a focal plane aligned at a non-zero viewing angle with respect to an x-y plane of a surface coordinate system, wherein the surface and the imaging sensor are in relative translational motion, and wherein the sensor images the surface to form a sequence of images thereof; a processor that: (a) determines a sharpness of focus value for every pixel in a last image in the sequence of images; (b) computes a y-coordinate in a surface coordinate system at which the focal plane intersects the y axis; (c) based on the apparent shift of the surface in the last image, determines transitional points on the surface, wherein the transitional points have exited a field of view of the lens in the last image, but were in the field of view of the lens in an image in the sequence previous to the last image; (d) determines the three dimensional location in a camera coordinate system of all the transitional points on the surface; (e) repeats steps (a) to (d) for each new image acquired by the imaging sensor; and (f) accumulates the three dimensional location in the camera coordinate system of the transitional points from the images in the sequence to form a point cloud representative of the translating surface.

In yet another aspect, the present disclosure is directed to an online computerized inspection system for inspecting web material in real time, the system including a stationary imaging sensor including a camera and a telecentric lens, wherein the lens has a focal plane aligned at a non-zero viewing angle with respect to an x-y plane of a moving surface, and wherein the sensor images the surface to form a sequence of images thereof; a processor that: (a) determines a sharpness of focus value for every pixel in a last image in the sequence of images; (b) computes a y-coordinate in a surface coordinate system at which the focal plane intersects the y axis; (c) based on the apparent shift of the surface in the last image, determines transitional points on the surface, wherein the transitional points have exited a field of view of the lens in the last image, but were in the field of view of the lens in an image in the sequence previous to the last image; (d) determines the three dimensional location in a camera coordinate system of all the transitional points on the surface; (e) repeats steps (a) to (d) for each new image acquired by the imaging sensor; and (f) accumulates the three dimensional location in the camera coordinate system of the transitional points from the images in the sequence to form a point cloud representative of the translating surface.

In yet another aspect, the present disclosure is directed to a non-transitory computer readable medium including software instructions to cause a computer processor to: (a) receive, with an online computerized inspection system, a sequence of images of a moving surface of a web material, wherein the sequence of images is captured with a stationary imaging sensor including a camera and a telecentric lens having a focal plane aligned at a non-zero viewing angle with respect to an x-y plane of a surface coordinate system; (b) determine a sharpness of focus value for every pixel in a last image in the sequence of images; (c) compute a y-coordinate in a surface coordinate system at which the focal plane intersects the y-axis; (d) based on the apparent shift of the surface in the last image, determine transitional points on the surface, wherein the transitional points have exited a field of view of the lens in the last image, but were in the field of view of the lens in an image in the sequence previous to the last image; (e) determine the three dimensional location in a camera coordinate system of all the transitional points on the surface; (f) repeat steps (a) to (e) for each new image acquired by the imaging sensor; and (g) accumulate the three dimensional location in the camera coordinate system of the transitional points from the images in the sequence to form a point cloud representative of the translating surface.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic diagram of an optical inspection apparatus.

FIG. 2 is a flowchart illustrating a method for determining the structure of a surface using the apparatus of FIG. 1.

FIG. 3 is a flowchart illustrating another method for determining the structure of a surface using the apparatus of FIG. 1.

FIG. 4 is a flowchart illustrating a method for processing the point cloud obtained from FIG. 3 to create a map of a surface.

FIG. 5 is a schematic block diagram of an exemplary embodiment of an inspection system in an exemplary web manufacturing plant.

FIG. 6 is a photograph of three images obtained by the optical inspection apparatus in Example 1.

FIGS. 7A-7C are three different views of the surface of the sample as determined by the optical inspection apparatus in Example 1.

FIGS. 8A-C are surface reconstructions formed using the apparatus of FIG. 1 as described in Example 3 at viewing angles θ of 22.3°, 38.1°, and 46.5°, respectively.

FIGS. 9A-C are surface reconstructions formed using the apparatus of FIG. 1 as described in Example 3 at viewing angles θ of 22.3°38.1°, and 46.5°, respectively.

### DETAILED DESCRIPTION

Currently available surface inspection systems have been unable to provide useful online information about 3D surface structure of a surface due to constraints on their resolutions, speeds, or fields-of-view. The present disclosure is directed to an online inspection system including a stationary sensor, and unlike DFF systems does not require translation of the focal plane of the imaging lens of the sensor. Rather, the system described in the present disclosure utilizes the translational motion of the surface to automatically pass points on the surface through various focal planes to rapidly provide a 3D model of the surface, and as such is useful for online inspection applications in which a web of material is continuously monitored as it is processed on a production line.

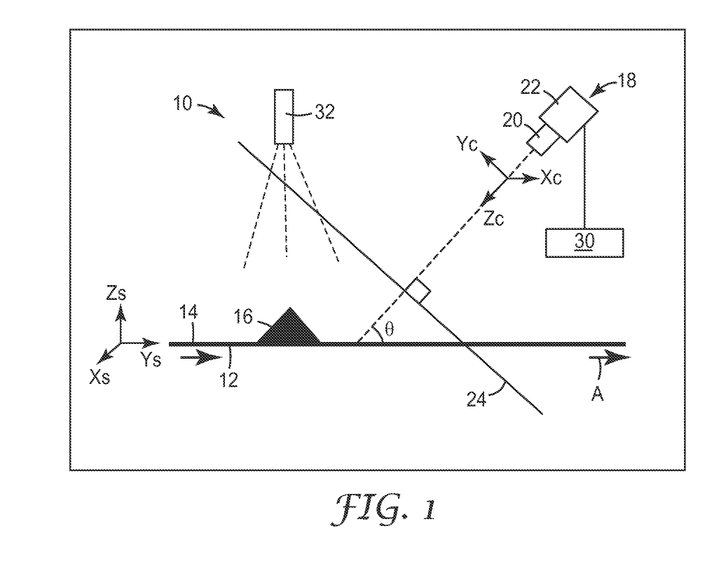

FIG. 1 is a schematic illustration of a sensor system 10, which is used to image a surface 14 of a material 12. The surface 14 is translated relative to at least one imaging sensor system 18. The surface 14 is imaged with the imaging sensor system 18, which is stationary in FIG. 1, although in other embodiments the sensor system 18 may be in motion while the surface 14 remains stationary. To further clarify the discussion below, it is assumed that relative motion of the imaging sensor system 18 and the surface 14 also creates two coordinate systems in relative motion with respect to one another. For example, as shown in FIG. 1 the imaging sensor system 18 can be described with respect to a camera coordinate system in which the z direction, z_{c}, is aligned with the optical axis of a lens 20 of a CCD or CMOS camera 22. Referring again to FIG. 1, the surface 14 can be described with respect to a surface coordinate system in which the axis zₛ is the height above the surface.

In the embodiment shown in FIG. 1, the surface 14 is moving along the direction of the arrow A along the direction yₛ at a known speed toward the imaging sensor system 18, and includes a plurality of features 16 having a three-dimensional (3D) structure (extending along the direction zₛ). However, in other embodiments the surface 14 may be moving away from the imaging sensor system 18 at a known speed. The translation direction of the surface 14 with respect to the imaging sensor system 18, or the number and/or position of the imaging sensors 18 with respect to the surface 14, may be varied as desired so that the imaging sensor system 18 may obtain a more complete view of areas of the surface 14, or of particular parts of the features 16. The imaging sensor system 18 includes a lens system 20 and a sensor included in, for example, the CCD or CMOS camera 22. At least one optional light source 32 may be used to illuminate the surface 14.

The lens 20 has a focal plane 24 that is aligned at a non-zero angle θ with respect to an x-y plane of the surface coordinate system of the surface 14. The viewing angle θ between the lens focal plane and the x-y plane of the surface coordinate system may be selected depending on the characteristics of the surface 14 and the features 16 to be analyzed by the system 10. In some embodiments θ is an acute angle less than 90°, assuming an arrangement such as in FIG. 1 wherein the translating surface 14 is moving toward the imaging sensor system 18. In other embodiments in which the surface 14 is moving toward the imaging sensor system 18, the viewing angle θ is about 20° to about 60°, and an angle of about 40° has been found to be useful. In some embodiments, the viewing angle θ may be periodically or constantly varied as the surface 14 is imaged to provide a more uniform and/or complete view of the features 16.

The lens system 20 may include a wide variety of lenses depending on the intended application of the apparatus 10, but telecentric lenses have been found to be particularly useful. In this application the term telecentric lens means any lens or system of lenses that approximates an orthographic projection. A telecentric lens provides no change in magnification with distance from the lens. An object that is too close or too far from the telecentric lens may be out of focus, but the resulting blurry image will be the same size as the correctly-focused image.

The sensor system 10 includes a processor 30, which may be internal, external or remote from the imaging sensor system 18. The processor 30 analyzes a series of images of the moving surface 14, which are obtained by the imaging sensor system 18.

The processor 30 initially registers the series of images obtained by the imaging sensor system 18 in a sequence. This image registration is calculated to align points in the series of images that correspond to the same physical point on the surface 14. If the lens 20 utilized by the system 10 is telecentric, the magnification of the images collected by the imaging sensor system 18 does not change with distance from the lens. As a result, the images obtained by the imaging sensor system 18 can be registered by translating one image with respect to another, and no scaling or other geometric deformation is required. While non-telecentric lenses 20 may be used in the imaging sensor system 18, such lenses may make image registration more difficult and complex, and require more processing capacity in the processor 30.

The amount that an image must be translated to register it with another image in the sequence depends on the translation of the surface 14 between images. If the translation speed of the surface 14 is known, the motion of the surface 14 sample from one image to the next as obtained by the imaging sensor system 18 is also known, and the processor 30 need only determine how much, and in which direction, the image should be translated per unit motion of the surface 14. This determination made by the processor 30 depends on, for example, the properties of the imaging sensor system 18, the focus of the lens 20, the viewing angle θ of the focal plane 24 with respect to the x-y plane of the surface coordinate system, and the rotation (if any) of the camera 22.

Assume two parameters Dₓ and D_{y}, which give the translation of an image in the x and y directions per unit motion of the physical surface 14. The quantities Dₓ and D_{y} are in the units of pixels/mm. If two images Iₜ₁(x,y) and Iₜ₂(x,y) are taken at times t₁ and t₂, respectively, and the processor 30 is provided with the distance d that the sample surface 14 moved from t₁ to t₂, then these images should be registered by translating Iₜ₂(x,y) according to the following formula:

Î_{T}_{₂}(x, y)=Iₜ_{₂}(x−dDₓ, y−dd_{y}).

The scale factors Dₓ and D_{y} can also be estimated offline through a calibration procedure. In a sequence of images, the processor 30 automatically selects and tracks distinctive key points as they translate through the sequence of images obtained by the imaging sensor system 18. This information is then used by the processor to calculate the expected displacement (in pixels) of a feature point per unit translation of the physical sample of the surface 14. Tracking may be performed by the processor using a normalized template matching algorithm.

Once all images of the surface 14 have been aligned, the processor 30 then stacks the registered sequence of images together along the direction z_{c} normal to the focal plane of the lens 20 to form a volume. Each layer in this volume is an image in the sequence, shifted in the x and y directions as computed in the registration. Since the relative position of the surface 14 is known at the time each image in the sequence was acquired, each layer in the volume represents a snapshot of the surface 14 along the focal plane 24 as it slices through the sample 14 at angle θ (see FIG. 1), at the location of the particular displacement at that time.

Once the image sequence has been aligned, the processor 30 then computes the sharpness of focus at each (x,y) location in the volume, wherein the plane of the (x,y) locations is normal to the z_{c} direction in the volume. Locations in the volume that contain no image data are ignored, since they can be thought of as having zero sharpness. The processor 30 determines the sharpness of focus using a sharpness metric. Several suitable sharpness metrics are described in Nayar and Nakagawa, Shape from Focus, IEEE Transactions on Pattern Recognition and Machine Intelligence, vol. 16, no. 8, pages 824-831 (1994).

For example, a modified Laplacian sharpness metric may be applied to compute the quantity

$${∇}_{M} I = \vert \frac{{\partial }^{2} I}{\partial {x}^{2}} \vert + \vert \frac{{\partial }^{2} I}{\partial {y}^{2}} \vert$$

at each pixel in all images in the sequence. Partial derivatives can be computed using finite differences. The intuition behind this metric is that it can be thought of as an edge detector—clearly regions of sharp focus will have more distinct edges than out-of-focus regions. After computing this metric, a median filter may be used to aggregate the results locally around each pixel in the sequence of images.

Once the processor 30 has computed the sharpness of focus value for all the images in the sequence, the processor 30 computes a sharpness of focus volume, similar to the volume formed in earlier steps by stacking the registered images along the z_{c} direction. To form the sharpness of focus volume, the processor replaces each (x,y) pixel value in the registered image volume by the corresponding sharpness of focus measurement for that pixel. Each layer (corresponding to an x-y plane in the plane x_{c}-y_{c}) in this registered stack is now a “sharpness of focus” image, with the layers registered as before, so that an image location corresponding to the same physical location on the surface 14 are aligned. As such, if one location (x,y) in the volume is selected, the sharpness of focus values observed moving through different layers in the z_{c}-direction, the sharpness of focus comes to a maximum value when the point imaged at that location comes into focus (i.e., when it intersects with the focal plane 24 of the camera 22), and that the sharpness value will decrease moving away from that layer in either direction along the z_{c} axis.

Each layer (corresponding to an x-y plane) in the sharpness of focus volume corresponds to one slice through the surface 14 at the location of the focal plane 24, so that as the sample 14 moves along the direction A, various slices through the surface 14 are collected at different locations along the surface thereof. As such, since each image in the sharpness of focus volume corresponds to a physical slice through the surface 14 at a different relative location, ideally the slice where a point (x,y) comes into sharpest focus determines the three dimensional (3D) position on the sample of the corresponding point. However, in practice the sharpness of focus volume contains a discrete set of slices, which may not be densely or uniformly spaced along the surface 14. So most likely the actual (theoretical) depth of maximum focus (the depth at which sharpness of focus is maximized) will occur between slices.

The processor 30 then estimates the 3D location of each point on the surface 14 by approximating the theoretical location of the slice in the sharpness of focus volume with the sharpest focus through that point.

In one embodiment, the processor approximates this theoretical location of sharpest focus by fitting a Gaussian curve to the measured sharpness of focus values at each location (x,y) through slice depths z_{c} in the sharpness of focus volume. The model for sharpness of focus values as a function of slice depth z_{c} is given by

$${f}_{( x , y )} ( z ) = exp ( \frac{- {( z - {z}_{m} )}^{2}}{σ} ) ,$$

where zₘ is the theoretical depth of maximum focus for the location (x,y) in the volume and σ is the standard deviation of the Gaussian that results at least in part from the depth of field of the imaging lens (see lens 20 in FIG. 1). This curve fitting can be done by minimizing a simple least-squares cost function.

In another embodiment, if the Gaussian algorithm is prohibitively computationally expensive or time consuming for use in a particular application, an approximate algorithm can be used that executes more quickly without substantially sacrificing accuracy. A quadratic function can be fit to the sharpness profile samples at each location (x,y), but only using the samples near the location with the maximum sharpness value. So, for each point on the surface, first the depth is found with the highest sharpness value, and a few samples are selected on either side of this depth. A quadratic function is fit to these few samples using the standard Least-Squares formulation, which can be solved in closed form. In rare cases, when there is noise in the data, the parabola in the quadratic function may open upwards—in this case, the result of the fit is discarded, and the depth of the maximum sharpness sample is simply used instead. Otherwise, the depth is taken as the location of the theoretical maximum of the quadratic function, which may in general lie between two of the discrete samples.

Once the theoretical depth of maximum focus zₘ is approximated for each location (x,y) in the volume, the processor 30 estimates the 3D location of each point on the surface of the sample. This point cloud is then converted into a surface model of the surface 14 using standard triangular meshing algorithms.

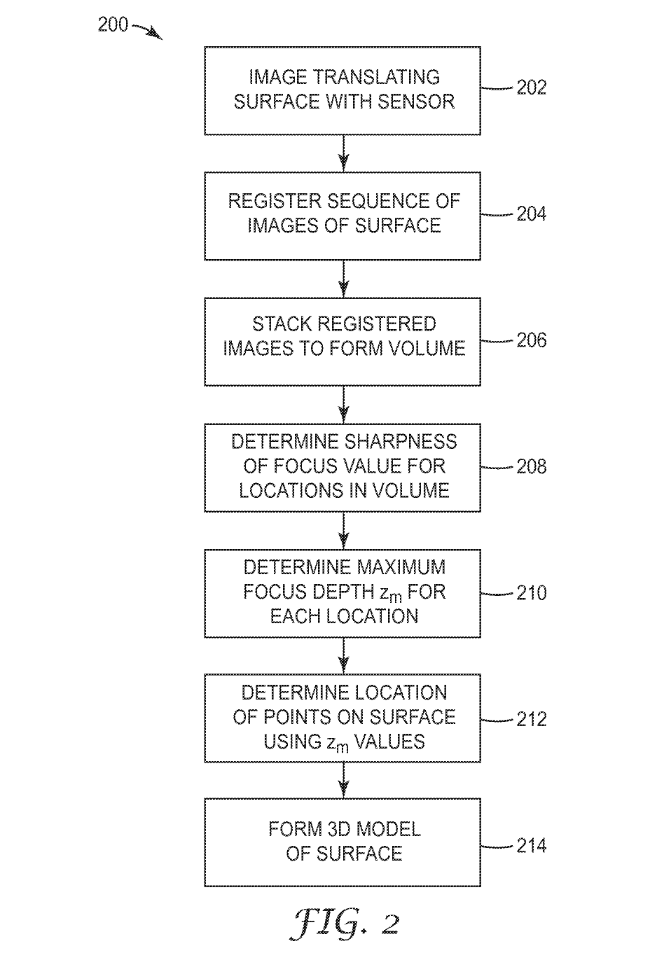

FIG. 2 is a flowchart illustrating a batch method 200 of operating the apparatus in FIG. 1 to characterize the surface in a sample region of a surface 14 of a material 12. In step 202, a translating surface is imaged with a sensor including a lens having a focal plane aligned at a non-zero angle with respect to a plane of the surface. In step 204, a processor registers a sequence of images of the surface, while in step 206 the registered images are stacked along a z_{c} direction to form a volume. In step 208 the processor determines a sharpness of focus value for each (x,y) location in the volume, wherein the (x,y) locations lie in a plane normal to the z_{c} direction. In step 210, the processor determines, using the sharpness of focus values, a depth of maximum focus zₘ along the z_{c} direction for each (x,y) location in the volume. In step 212, the processor determines, based on the depths of maximum focus zₘ, a three dimensional location of each point on the surface. In optional step 214, the processor can form, based on the three-dimensional locations, a three-dimensional model of the surface.

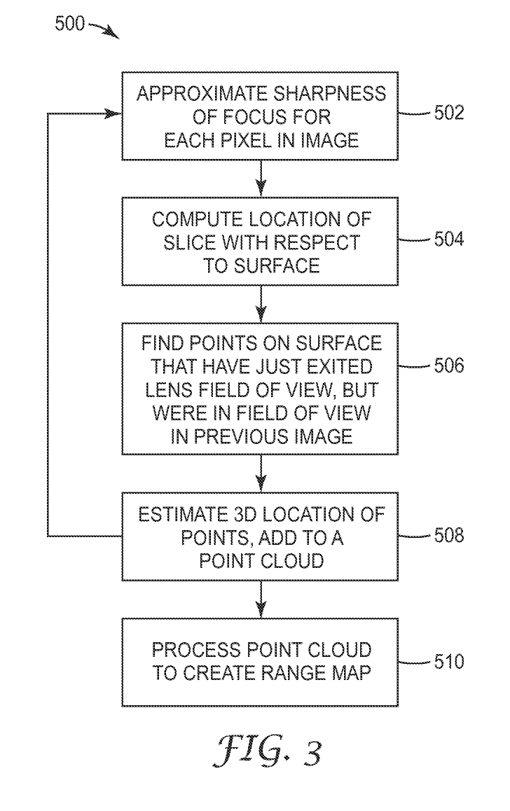

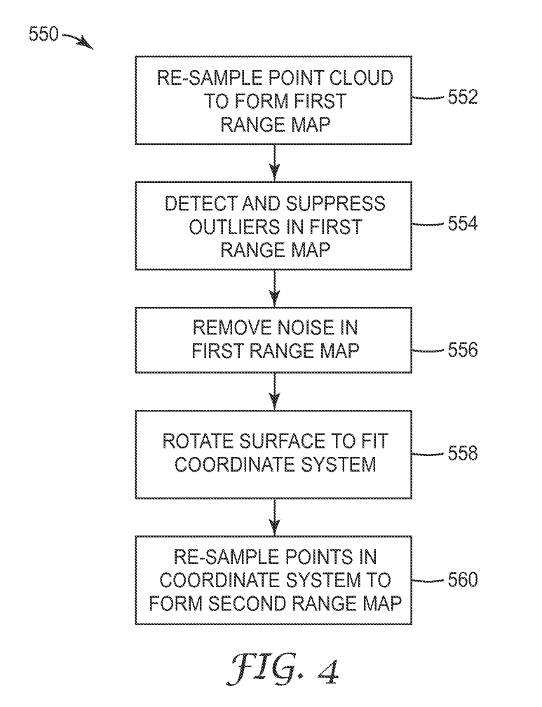

In the overall procedure described in FIG. 2, the processor 30 operates in batch mode, meaning that all images are processed together after they are acquired by the imaging sensor system 18. However, in other embodiments, the image data obtained by the imaging sensor system 18 may be processed incrementally as these data become available. As further explained in FIG. 3 below, the incremental processing approach utilizes an algorithm that proceeds in two phases. First, online, as the surface 14 translates and new images are acquired sequentially, the processor 30 estimates the 3D locations of points on the surface 14 as they are imaged. The result from this online processing is a set of 3D points (i.e., a point cloud) representing the surface 14 of the sample material 12. Then, offline, (after all images have been acquired and the 3D locations estimated), this point cloud is post-processed (FIG. 4) to generate a smooth range-map in an appropriate coordinate system.

Referring to the process 500 in FIG. 3, as the surface 14 translates with respect to the imaging sensor system 18, a sequence of images is acquired by the imaging sensor system 18. Each time a new image is acquired in the sequence, in step 502 the processor 30 approximates the sharpness of focus for each pixel in the newly acquired image using an appropriate algorithm such as, for example, the modified Laplacian sharpness metric described in detail in the discussion of the batch process above. In step 504, the processor 30 then computes a y-coordinate in the surface coordinate system at which the focal plane 24 intersects the y axis. In step 506, based on the apparent shift of the surface in the last image in the sequence, the processor finds transitional points on the surface 14 that have just exited the field of view of the lens 20, but which were in the field of view in the previous image in the sequence. In step 508, the processor then estimates the 3D location of all such transitional points. Each time a new image is received in the sequence, the processor repeats the estimation of the 3D location of the transitional points, then accumulates these 3D locations to form a point cloud representative of the surface 14.

Although the steps in FIG. 3 are described serially, to enhance efficiency the incremental processing approach can also be implemented as a multi-threaded system. For example, step 502 may be performed in one thread, while steps 504-508 occur in another thread. In step 510, the point cloud is further processed as described in FIG. 4 to form a range map of the surface 14.

Referring to the process 550 of FIG. 4, in step 552 the processor 30 forms a first range map by re-sampling the points in the point cloud on a rectangular grid, parallel to the image plane 24 of the camera 20. In step 554, the processor optionally detects and suppresses outliers in the first range map. In step 556, the processor performs an optional additional de-noising step to remove noise in the map of the reconstructed surface. In step 558, the reconstructed surface is rotated and represented on the surface coordinate system in which the X-Y plane xₛ-yₛ is aligned with the plane of motion of the surface 14, with the zₛ axis in the surface coordinate system normal to the surface 14. In step 560, the processor interpolates and re-samples on a grid in the surface coordinate system to form a second range map. In this second range map, for each (x,y) position on the surface, with the X axis (xₛ) being normal to the direction A (FIG. 1) and the Y axis (yₛ) being parallel to direction A, the Z-coordinate (zₛ) gives the surface height of a feature 16 on the surface 14.

For example, the surface analysis method and apparatus described herein are particularly well suited, but are not limited to, inspecting and characterizing the structured surfaces 14 of web-like rolls of sample materials 12 that include piece parts such as the feature 16 (FIG. 1). In general, the web rolls may contain a manufactured web material that may be any sheet-like material having a fixed dimension in one direction (cross-web direction generally normal to the direction A in FIG. 1) and either a predetermined or indeterminate length in the orthogonal direction (down-web direction generally parallel to direction A in FIG. 1). Examples include, but are not limited to, materials with textured, opaque surfaces such as metals, paper, woven materials, non-woven materials, glass, abrasives, flexible circuits or combinations thereof. In some embodiments, the apparatus of FIG. 1 may be utilized in one or more inspection systems to inspect and characterize web materials during manufacture. To produce a finished web roll that is ready for conversion into individual sheets for incorporation into a product, unfinished web rolls may undergo processing on multiple process lines either within one web manufacturing plant, or within multiple manufacturing plants. For each process, a web roll is used as a source roll from which the web is fed into the manufacturing process. After each process, the web may be converted into sheets or piece parts, or may be collected again into a web roll and moved to a different product line or shipped to a different manufacturing plant, where it is then unrolled, processed, and again collected into a roll. This process is repeated until ultimately a finished sheet, piece part or web roll is produced. For many applications, the web materials for each of the sheets, pieces, or web rolls may have numerous coatings applied at one or more production lines of the one or more web manufacturing plants. The coating is generally applied to an exposed surface of either a base web material, in the case of a first manufacturing process, or a previously applied coating in the case of a subsequent manufacturing process. Examples of coatings include adhesives, hardcoats, low adhesion backside coatings, metalized coatings, neutral density coatings, electrically conductive or nonconductive coatings, or combinations thereof.

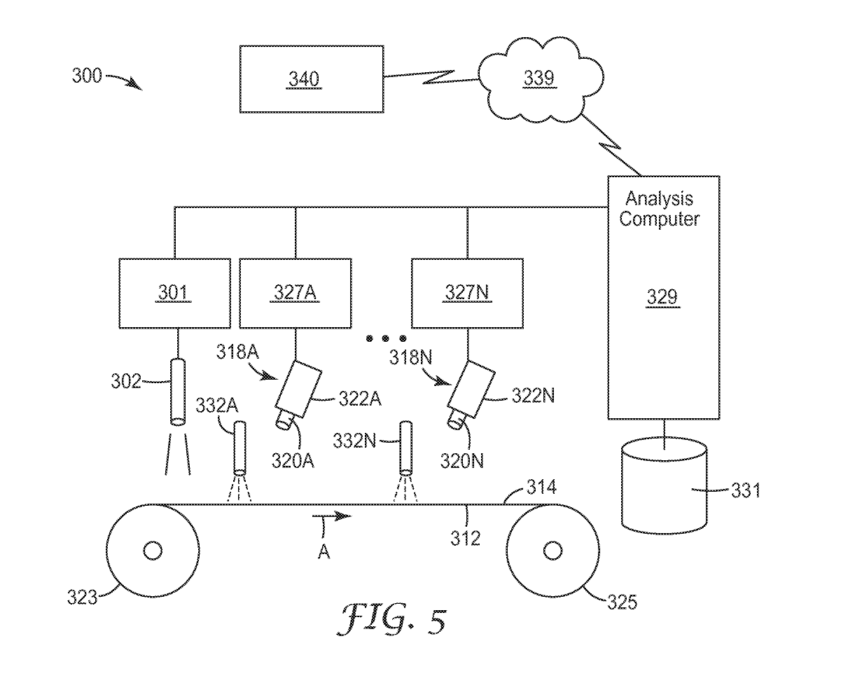

In the exemplary embodiment of an inspection system 300 shown in FIG. 5, a sample region of a web 312 is positioned between two support rolls 323, 325. The inspection system 300 includes a fiducial mark controller 301, which controls fiducial mark reader 302 to collect roll and position information from the sample region 312. In addition, the fiducial mark controller 301 may receive position signals from one or more high-precision encoders engaged with selected sample region of the web 312 and/or support rollers 323, 325. Based on the position signals, the fiducial mark controller 301 determines position information for each detected fiducial mark. The fiducial mark controller 301 communicates the roll and position information to an analysis computer 329 for association with detected data regarding the dimensions of features on a surface 314 of the web 312.

The system 300 further includes one or more stationary sensor systems 318A-318N, which each include an optional light source 332 and a telecentric lens 320 having a focal plane aligned at an acute angle with respect to the surface 314 of the moving web 312. The sensor systems 318 are positioned in close proximity to a surface 314 of the continuously moving web 312 as the web is processed, and scan the surface 314 of the web 312 to obtain digital image data.

An image data acquisition computer 327 collects image data from each of the sensor systems 318 and transmits the image data to an analysis computer 329. The analysis computer 329 processes streams of image data from the image acquisition computers 327 and analyzes the digital images with one or more of the batch or incremental image processing algorithms described above. The analysis computer 329 may display the results on an appropriate user interface and/or may store the results in a database 331.

The inspection system 300 shown in FIG. 5 may be used within a web manufacturing plant to measure the 3D characteristics of the web surface 314 and identify potentially defective materials. Once the 3D structure of a surface is estimated, the inspection system 300 may provide many types of useful information such as, for example, locations, shapes, heights, fidelities, etc. of features on the web surface 314. The inspection system 300 may also provide output data that indicates the severity of defects in any of these surface characteristics in real-time as the web is manufactured. For example, the computerized inspection systems may provide real-time feedback to users, such as process engineers, within web manufacturing plants regarding the presence of structural defects, anomalies, or out of spec materials (hereafter generally referred to as defects) in the web surface 314 and their severity, thereby allowing the users to quickly respond to an emerging defect in a particular batch of material or series of batches by adjusting process conditions to remedy a problem without significantly delaying production or producing large amounts of unusable material. The computerized inspection system 300 may apply algorithms to compute the severity level by ultimately assigning a rating label for the defect (e.g., “good” or “bad”) or by producing a measurement of non-uniformity severity of a given sample on a continuous scale or more accurately sampled scale.

The analysis computer 329 may store the defect rating or other information regarding the surface characteristics of the sample region of the web 314, including roll identifying information for the web 314 and possibly position information for each measured feature, within the database 331. For example, the analysis computer 329 may utilize position data produced by fiducial mark controller 301 to determine the spatial position or image region of each measured area including defects within the coordinate system of the process line. That is, based on the position data from the fiducial mark controller 301, the analysis computer 329 determines the xₛ, yₛ, and possibly zₛ position or range for each area of non-uniformity within the coordinate system used by the current process line. For example, a coordinate system may be defined such that the x dimension (xₛ) represents a distance across web 312, a y dimension (yₛ) represents a distance along a length of the web, and the z dimension (zₛ) represents a height of the web, which may be based on the number of coatings, materials or other layers previously applied to the web. Moreover, an origin for the x, y, z coordinate system may be defined at a physical location within the process line, and is typically associated with an initial feed placement of the web 312.

The database 331 may be implemented in any of a number of different forms including a data storage file or one or more database management systems (DBMS) executing on one or more database servers. The database management systems may be, for example, a relational (RDBMS), hierarchical (HDBMS), multidimensional (MDBMS), object oriented (ODBMS or OODBMS) or object relational (ORDBMS) database management system. As one example, the database 331 is implemented as a relational database available under the trade designation SQL Server from Microsoft Corporation, Redmond, Wash.

Once the process has ended, the analysis computer 329 may transmit the data collected in the database 331 to a conversion control system 340 via a network 339. For example, the analysis computer 329 may communicate the roll information as well as the feature dimension and/or anomaly information and respective sub-images for each feature to the conversion control system 340 for subsequent, offline, detailed analysis. For example, the feature dimension information may be communicated by way of database synchronization between the database 331 and the conversion control system 340.

In some embodiments, the conversion control system 340 may determine those products of products for which each anomaly may cause a defect, rather than the analysis computer 329. Once data for the finished web roll has been collected in the database 331, the data may be communicated to converting sites and/or used to mark anomalies on the web roll, either directly on the surface of the web with a removable or washable mark, or on a cover sheet that may be applied to the web before or during marking of anomalies on the web.

The components of the analysis computer 329 may be implemented, at least in part, as software instructions executed by one or more processors of the analysis computer 329, including one or more hardware microprocessors, digital signal processors (DSPs), application specific integrated circuits (ASICs), field programmable gate arrays (FPGAs), or any other equivalent integrated or discrete logic circuitry, as well as any combinations of such components. The software instructions may be stored within in a non-transitory computer readable medium, such as random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media.

Although shown for purposes of example as positioned within a manufacturing plant, the analysis computer 329 may be located external to the manufacturing plant, e.g., at a central location or at a converting site. For example, the analysis computer 329 may operate within the conversion control system 340. In another example, the described components execute on a single computing platform and may be integrated into the same software system.

The subject matter of the present disclosure will now be described with reference to the following non-limiting examples.

### EXAMPLES

### Example 1

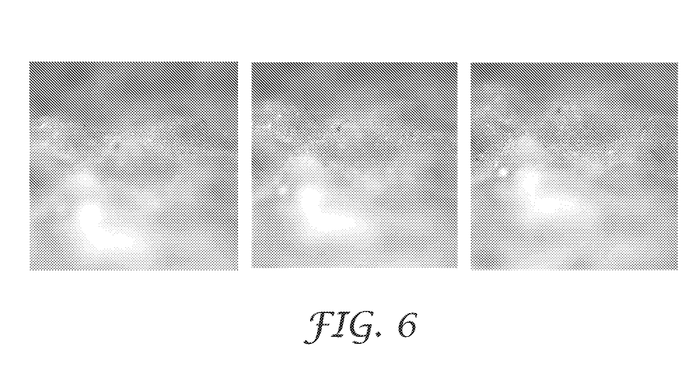

An apparatus was constructed in accordance with the schematic in FIG. 1. A CCD camera including a telecentric lens was directed at a sample abrasive material on a moveable stage. The focal plane of the telecentric lens was oriented at a viewing angle (θ in FIG. 1) of approximately 40° with respect to the x-y plane of the surface coordinate system of the sample material. The sample material was translated horizontally on the stage in increments of approximately 300 μm, and an image was captured by the camera at each increment. FIG. 6 shows three images of the surface of the sample material taken by the camera as the sample material was moved through a series of 300 μm increments.

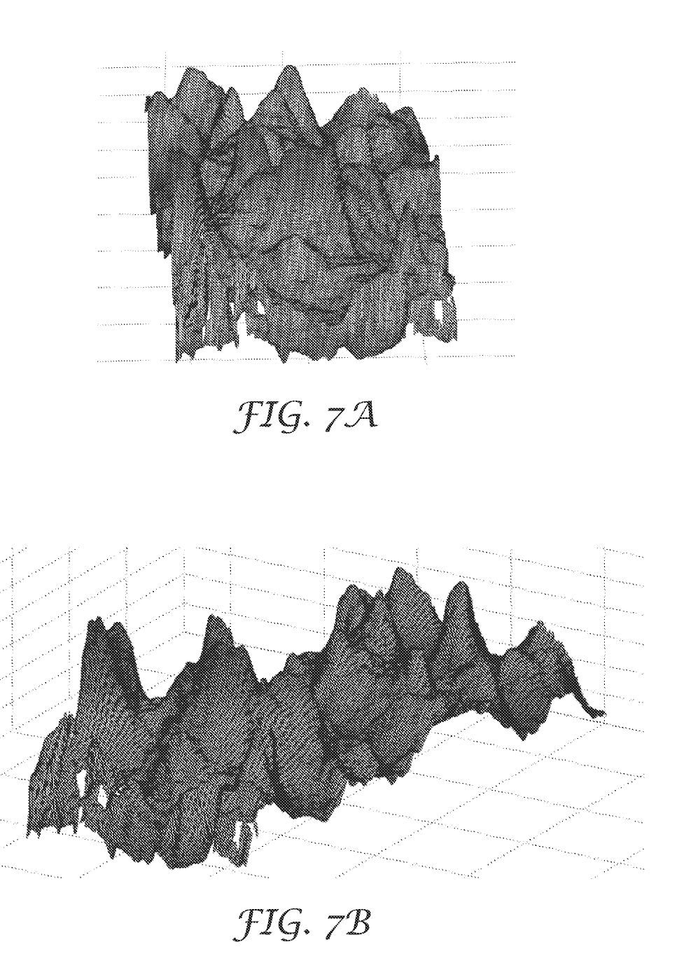

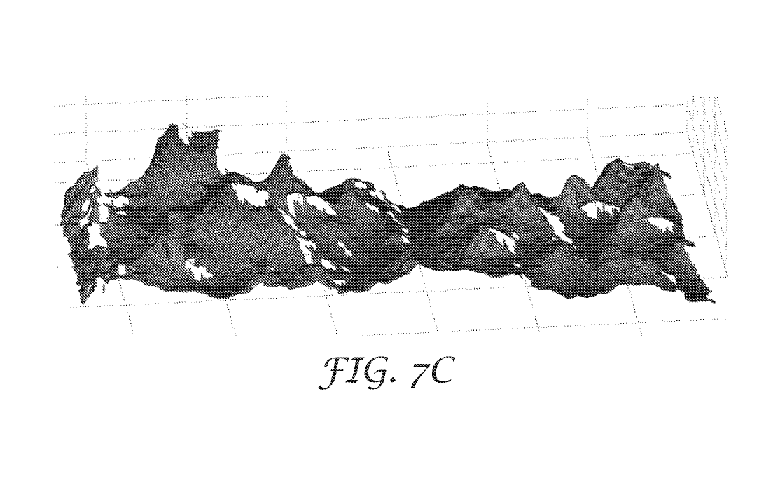

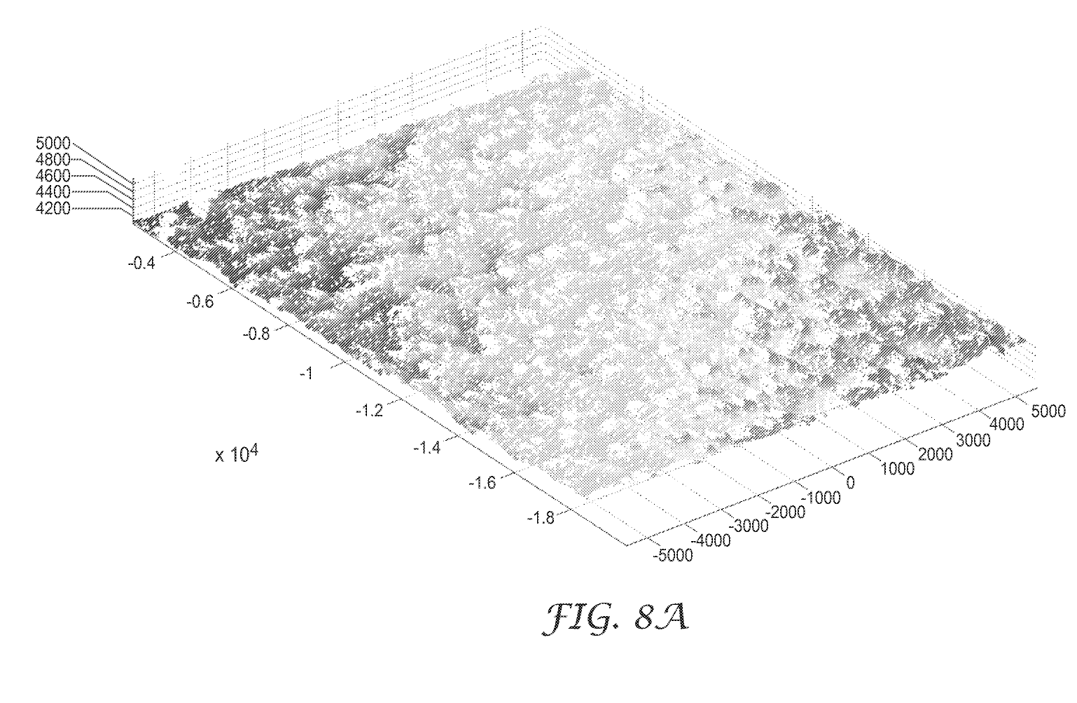

A processor associated with an analysis computer analyzed the images of the sample surface acquired by the camera. The processor registered a sequence of the images, stacked the registered images along a z_{c} direction to form a volume, and determined a sharpness of focus value for each (x,y) location in the volume using the modified Laplacian sharpness of focus metric described above. Using the sharpness of focus values, the processor computed a depth of maximum focus zₘ along the z_{c} direction for each (x,y) location in the volume and determined, based on the depths of maximum focus zₘ, a three dimensional location of each point on the surface of the sample. The computer formed, based on the three-dimensional locations, a three-dimensional model of the surface of FIG. 6, which is shown in FIGS. 7A-7C from three different perspectives.

The reconstructed surface in the images shown in FIGS. 7A-7C is realistic and accurate, and a number of quantities of interest could be computed from this surface, such as feature sharpness, size and orientation in the case of a web material such as an abrasive. However, FIG. 7C shows that that there are several gaps or holes in the reconstructed surface. These holes are a result of the manner in which the samples were imaged. As shown schematically in FIG. 1, the parts of the surface on the backside of tall features on the sample (in this case, grains on the abrasive), can never be viewed by the camera due to the relatively low angle of view. This lack of data could potentially be alleviated through the use of two cameras viewing the sample simultaneously from different angles.

### Example 2

Several samples of an abrasive material were scanned by the incremental process described in this disclosure. The samples were also scanned by an off line laser profilometer using a confocal sensor. Two surface profiles of each sample were then reconstructed from the data sets obtained from the different methods, and the results were compared by registering the two reconstructions using a variant of the Iterated Closest-Point (ICP) matching algorithm described in Chen and Medioni, Object Modeling by Registration of Multiple Range Images, Proceedings of the IEEE International Conference on Robotics and Automation, 1991. The surface height estimates zₛ for each location (x, y) on the samples were then compared. Using a lens with a magnification of 2, sample 1 showed a median range residual value of 12 μm, while Sample 2 showed a median range residual value of 9 μm. Even with an imprecise registration, the scans from the incremental processing technique described above matched relatively closely to a scan taken by the off-line laser profilometer.

### Example 3

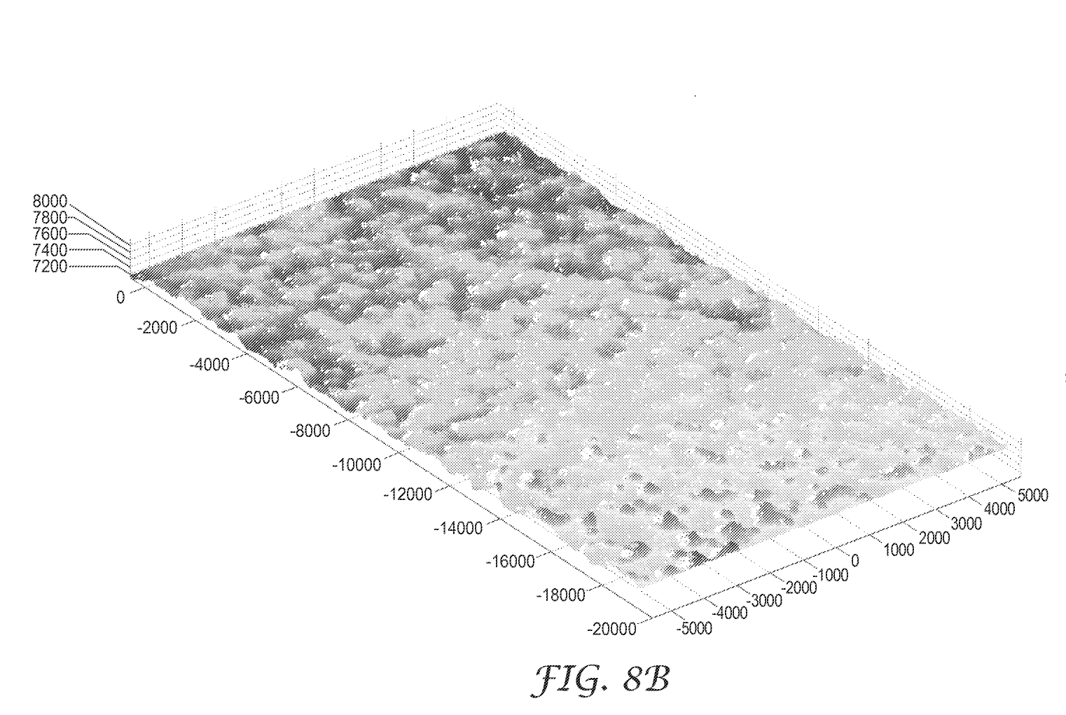

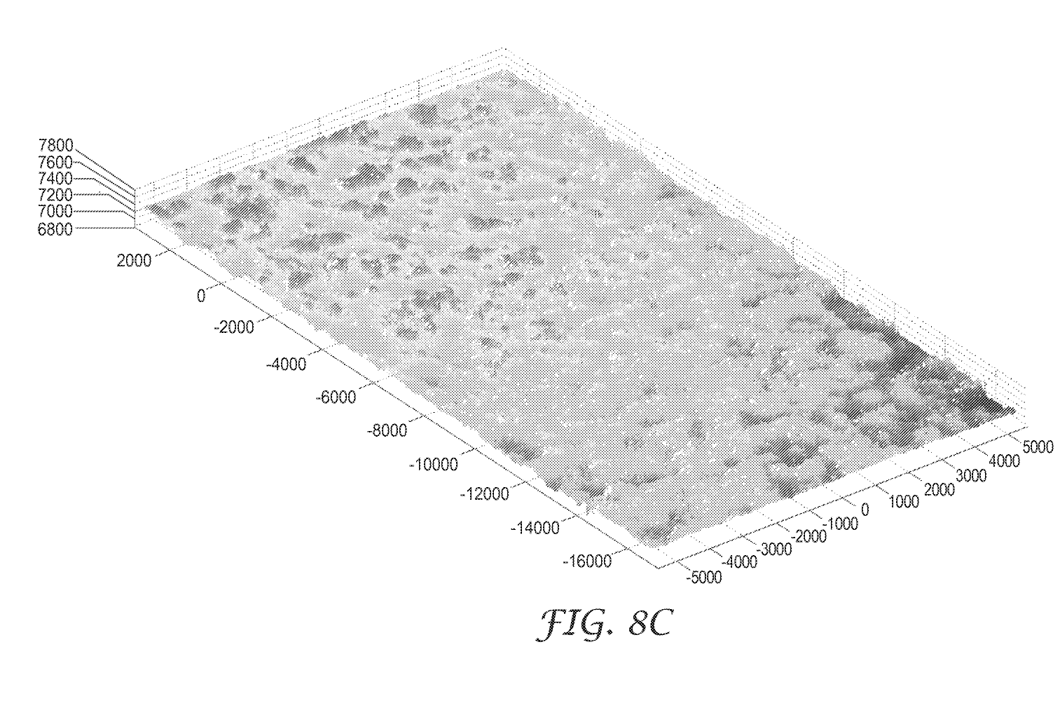

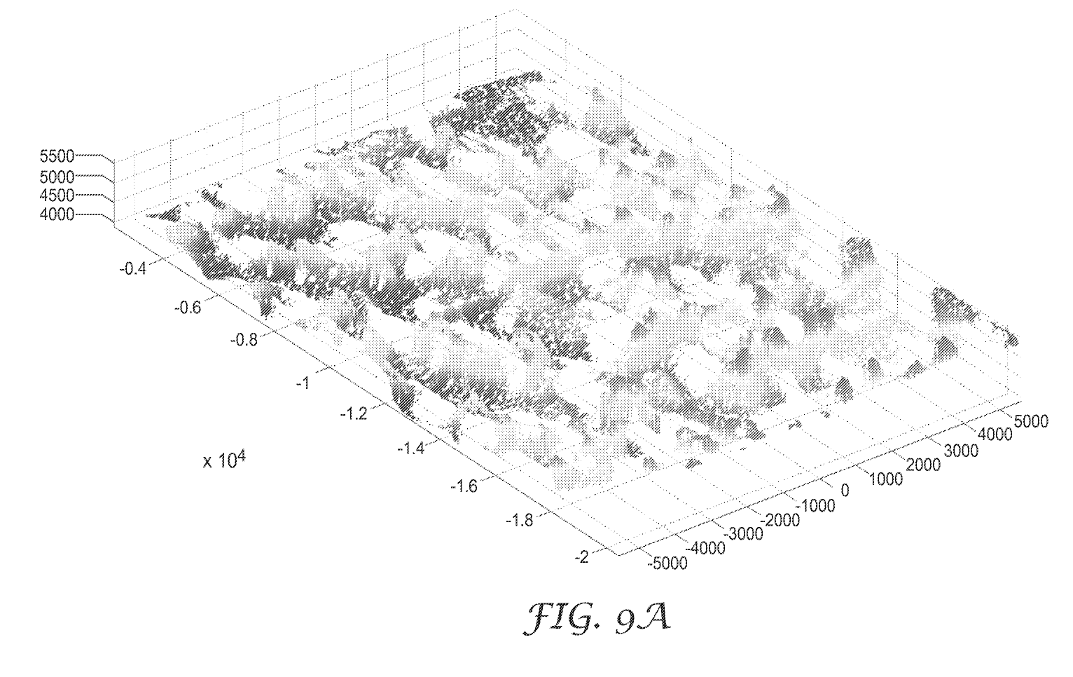

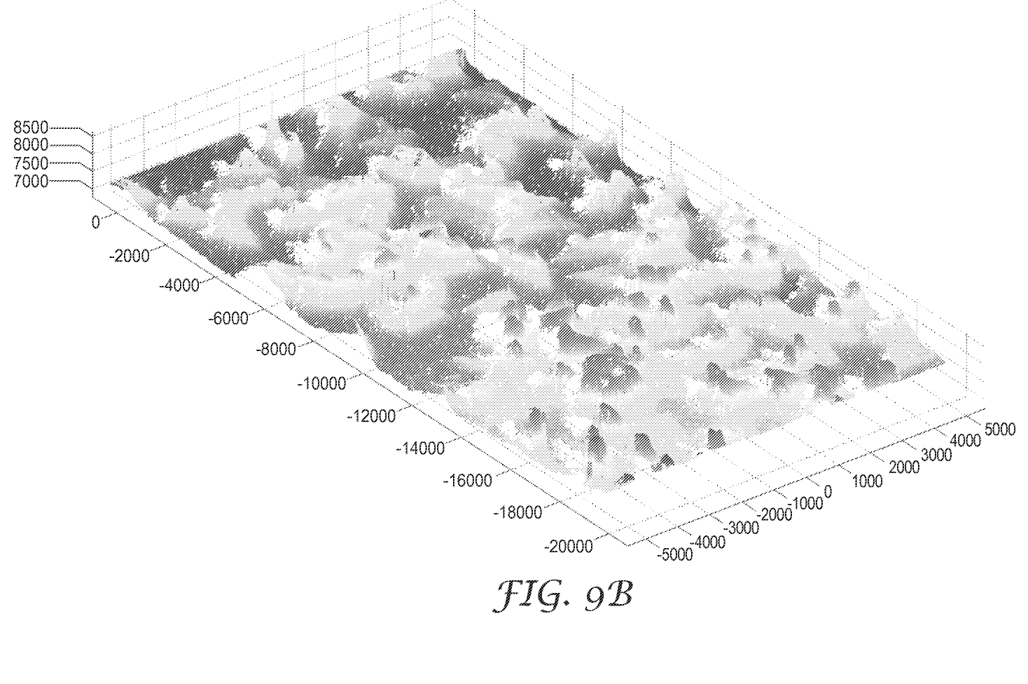

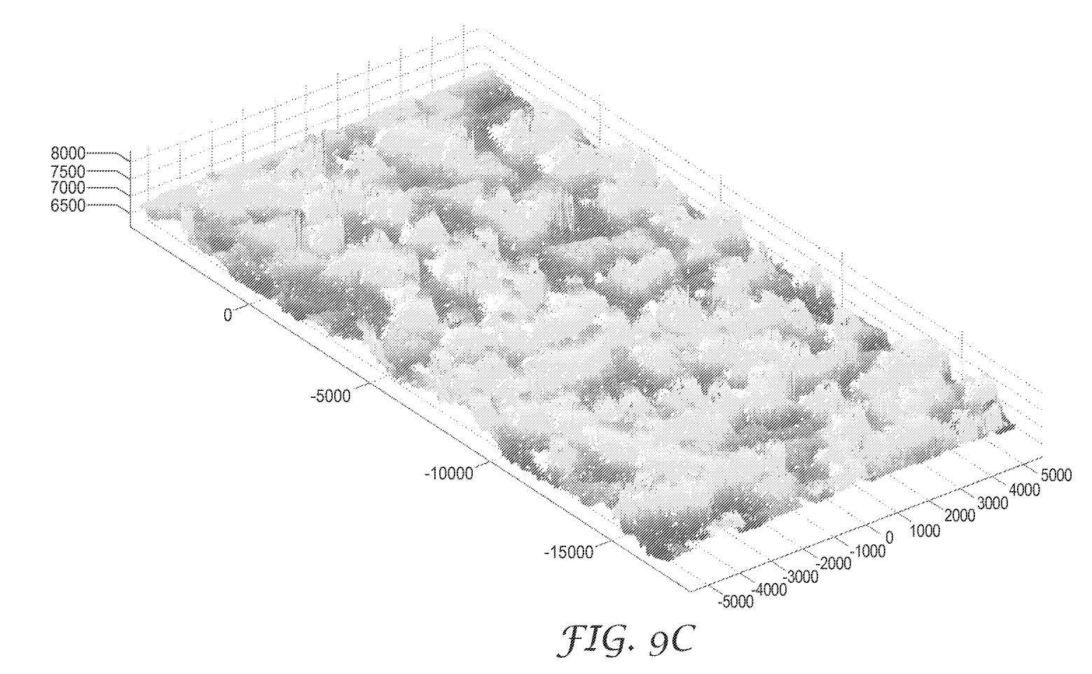

In this example, the effect on the reconstructed 3D surface of the camera incidence angle θ (FIG. 1) was evaluated by reconstructing 8 different samples (of various types), each from three different viewing angles: θ=22:3°; 38:1°; and 46:5° (the surface of the samples was moving toward the camera as shown in FIG. 1). Examples of 3D reconstructions of two different surfaces from these different viewing angles of 22:3°; 38:1°; and 46:5° are shown in FIGS. 8A-C and 9A-C, respectively. Based on these results, as well as reconstructions of the other samples (not shown in FIGS. 8-9), some qualitative observations can be made.

First, surfaces reconstructed with smaller viewing angles exhibit larger holes in the estimated surface. This is especially pronounced behind tall peaks, as shown in FIG. 9A. This is to be expected, since more of the surface behind these peaks is occluded from the camera when is small. The result is that the overall surface reconstruction is less complete than from higher viewing angles.

Second, it can also be observed that, while larger viewing angles (such as in FIG. 8C and 9C yield more complete reconstructions, they also result in a higher level of noise in the surface estimate. This is more apparent on steep vertical edges on the surface. This is most likely due to the sensitivity to noise being increased by having fewer pixels on target on steep vertical edges, since the viewing angle is closer to top-down.

Based on these observations, as well as subjective visual inspection of all the results of this experiment, it appears that the middle viewing angle (38:1°) yields the most pleasing results of all the configurations evaluated in this Example. Sequences reconstructed in this manner seem to strike a balance between completeness and low noise levels.

Various embodiments of the invention have been described. These and other embodiments are within the scope of the following claims.

1-15. (canceled)

16. An apparatus, comprising:
an imaging sensor comprising a telecentric lens, wherein the lens has a focal plane aligned at a non-zero viewing angle with respect to an x-y plane in a surface coordinate system, wherein the surface and the imaging sensor are in relative translational motion, and wherein the sensor images the surface to form a sequence of images thereof;
a processor that:
aligns in each image in the sequence a reference point on the surface to form a registered sequence of images;
stacks the registered sequence of images along a z direction in a camera coordinate system to form a volume, wherein each image in the registered sequence of images comprises a layer in the volume;
computes a sharpness of focus value for each pixel within the volume, wherein the pixels lie in a plane normal to the z direction in the camera coordinate system;
computes, based on the sharpness of focus values, a depth of maximum focus value zₘ for each pixel within the volume;
determines, based on the depths of maximum focus zₘ, a three dimensional location of each point on the surface; and
constructs a three-dimensional model of the surface based on the three dimensional locations, optionally wherein the surface is a web of material.

17. (canceled)

18. The apparatus of claim 16, further comprising a light source to illuminate the surface.

19. The apparatus of claim 16, wherein the sensor comprises a CCD or a CMOS camera.

20. The apparatus of claim 19, wherein the processor is internal to the camera.

21. The apparatus of claim 19, wherein the processor is remote from the camera.

22. A method, comprising:
positioning a stationary imaging sensor at a non-zero viewing angle with respect to a moving web of material, wherein the imaging sensor comprises a telecentric lens to image a surface of the moving web and form a sequence of images thereof;
processing the sequence of images to:
register the images;
stack the registered images along a z direction in a camera coordinate system to form a volume;
determine a sharpness of focus value for each (x,y) location in the volume, wherein the (x,y) locations lie in a plane normal to the z direction in the camera coordinate system;
determine a depth of maximum focus zₘ along the z direction in the camera coordinate system for each (x,y) location in the volume; and
determine, based on the depths of maximum focus zₘ, a three dimensional location of each point on the surface of the moving web, optionally wherein the imagine sensor comprises a CCD or a CMOS camera.

23-24. (canceled)

25. The method of claim 22, further comprising forming, based on the three-dimensional locations, a three-dimensional model of the surface of the moving web.

26. The method of claim 22, wherein the sharpness of focus value is determined by applying a modified Laplacian sharpness metric at each (x,y) location.

27. The method of claim 22, wherein the depth of each point on the surface is determined by fitting along the z direction a Gaussian curve to estimate the depths of maximum focus zₘ.

28. The method of claim 22, wherein the depth of each point on the surface is determined by fitting a quadratic function to the sharpness of focus values at each location (x,y), in the volume.

29. The method of claim 22, comprising applying a triangular meshing algorithm to the three dimensional point locations to form the model of the surface.

30-50. (canceled)

51. A method for inspecting a moving surface of a web material in real time and computing a three-dimensional model of the surface, the method comprising:
(a) capturing with a stationary sensor a sequence of images of the surface, wherein the imaging sensor comprises a camera and a telecentric lens having a focal plane aligned at a non-zero viewing angle with respect to an x-y plane of a surface coordinate system;
(b) determining a sharpness of focus value for every pixel in a last image in the sequence of images;
(c) computing a y-coordinate in a surface coordinate system at which the focal plane intersects the y-axis;
(d) based on the apparent shift of the surface in the last image, determining transitional points on the surface, wherein the transitional points have exited a field of view of the lens in the last image, but were in the field of view of the lens in an image in the sequence previous to the last image;
(e) determining the three dimensional location in a camera coordinate system of all the transitional points on the surface;
(f) repeating steps (a) to (f) for each new image acquired by the imaging sensor; and
(g) accumulating the three dimensional location in the camera coordinate system of the transitional points from the images in the sequence to form a point cloud representative of the translating surface, optionally wherein the sharpness of focus value is determined by applying a modified Laplacian sharpness metric.

52. (canceled)

53. The method of claim 51, wherein the three dimensional location of each transitional point on the surface is determined by fitting along the z direction in the camera coordinate system a Gaussian curve to estimate the depths of maximum focus zₘ.

54. The method of claim 51, wherein the three dimensional location of each transitional point on the surface is determined by fitting a quadratic function to the sharpness of focus values for each pixel.

55. The method of claim 51, further comprising forming a first range map of the translating surface by re-sampling the points in the point cloud on a rectangular grid in the camera coordinate system.

56. The method of claim 55, further comprising removing noise from the first range map.

57. The method of claim 51, further comprising rotating the first range map to a surface coordinate system.

58. The method of claim 57, further comprising forming a second range map by re-sampling first range map on a grid in the surface coordinate system.

59. The method of claim 51, wherein, when the surface is moving toward a stationary imaging sensor, the viewing angle is about 38°.

60. An online computerized inspection system for inspecting web material in real time, the system comprising:
a stationary imaging sensor comprising a camera and a telecentric lens, wherein the lens has a focal plane aligned at a non-zero viewing angle with respect to an x-y plane of a moving surface, and wherein the sensor images the surface to form a sequence of images thereof;
a processor that:
(a) determines a sharpness of focus value for every pixel in a last image in the sequence of images;
(b) computes a y-coordinate in a surface coordinate system at which the focal plane intersects the y axis;
(c) based on the apparent shift of the surface in the last image, determines transitional points on the surface, wherein the transitional points have exited a field of view of the lens in the last image, but were in the field of view of the lens in an image in the sequence previous to the last image;
(d) determines the three dimensional location in a camera coordinate system of all the transitional points on the surface;
(e) repeats steps (a) to (d) for each new image acquired by the imaging sensor; and
(f) accumulates the three dimensional location in the camera coordinate system of the transitional points from the images in the sequence to form a point cloud representative of the translating surface.

61. (canceled)
